(19) United States
(12) Patent Application Publication
(10) Pub. No.: US 2009/0040227 A1
(43) Pub. Date: Feb. 12, 2009

(54) Indicators for Interactive Analysis of Virtual Three-Dimensional Machine Data

(76) Inventor: Joseph A. Vrba, Clinton, TN (US)

Correspondence Address: LUEDEKA, NEELY & GRAHAM, P.C., P O BOX 1871, KNOXVILLE, TN, 37901, US

(21) Appl. No.: 11/834,267

(22) Filed: Aug. 6, 2007

(51) Int. Cl. G06T 11/20

(52) U.S. Cl. 345/440

(57) ABSTRACT

Methods for displaying machine data are described including a method for displaying machine data as an image showing a three-dimensional graph having three axes and one or more cursor images representing substantially planar cursors on the display for analyzing data.

### FIELD

This invention relates to the field of machine performance analysis. More particularly, this invention relates to displays for enhancing the ability of a user to analyze machine performance data.

### BACKGROUND AND SUMMARY

In accordance with one embodiment, a method is provided for displaying machine data via a virtual three-dimensional display to enhance the user's ability to analyze the machine data. A three dimensional graph of machine data is displayed and a cursor is also displayed in the graph in the form of one or more planes cutting through the three dimensional machine data. A user provides commands through an input device such as a mouse, button, or touch screen, and the cursor moves to different positions corresponding to the inputs provided by a user. Information corresponding to the machine data at the position of the cursor is displayed on or proximate to the graph so that a user may position the cursor at a point of interest on the machine data and read information corresponding to the machine data at such point of interest.

In accordance with a more particular embodiment, the cursor is one or more semi-transparent planes that are positioned over the machine data to partially obscure a portion of the data. The machine data that is behind the plane(s) is still visible, but it is dimmed out to some extent by the cursor. For example, if the cursor were a semi-transparent gray plane, the machine data in front of the plane would be visible as usual, but the data behind the plane would be grayed out a bit as if the data were in a shadow or were being viewed through gray tinted glass. When more than one plane is displayed, the user may move each independently to indicate locations in different dimensions of the machine data. Alternately, secondary and tertiary dimensions can be indicated by highlighting data sets or by drawing a line or other symbol to indicate selection of points within the data. These alternate indicators can also move independently in their respective data dimensions.

In certain applications, multiple cursors can take the form of multiple planar cursors. For example harmonic cursors include a plurality of parallel semi-transparent plane cursors spaced apart equidistantly along a substantially horizontal axis which represents frequency. Thus each semi-transparent planar cursor would be spaced apart from the other semi-transparent planar cursors by the same distance representing the same frequency. By user inputs the user may change the distance between each planar cursor, or move all of the planar cursors at one time left or right along the horizontal axis holding their respective spacing constant. By providing user input commands, the user may select one or more data points using these cursors, and the data displayed on or proximate to the graph will correspond to the selected data point. The displayed data may also include the distance between each planar cursor, and in the case of the horizontal axis representing frequency, the distance between the planar cursors is a measurement of frequency.

A user may also enter commands to create multiple planar cursors that are not a harmonic cursor and in such case the planar cursors may be positioned independently such that the distances between the cursors are not necessarily the same.

The machine data may be vibration spectra where the horizontal axis represents frequency, a substantially vertical axis represents some type of magnitude (e.g., displacement, velocity, or acceleration) and an axis defining depth (the depth axis) represents time or rotation rate. Along the depth axis different spectra obtained at different times or rotations are displayed.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIGS. 1-4 are two-dimensional displays of machine data found in the prior art;

FIGS. 5-7 are three-dimensional displays of machine data attempting cursor manipulation using methods found in the prior art;

FIGS. 8-12 are three-dimensional displays of machine data illustrating semi-transparent planar cursors; and

FIGS. 13-17 are three-dimensional displays of machine data illustrating a number of applications of semi-transparent planar cursors.

### DETAILED DESCRIPTION

Machine data, such as vibration data, flux data, and voltage data, is collected in a number of ways and analyzed to determine the operating characteristics and possible problems of machinery or other objects of interest. For example, periodic vibration data is often collected using a portable instrument, such as a CSI Model 2130 manufactured by Computational Systems, Inc. In such case, the vibration data is analyzed on the portable unit itself and the vibration data is also uploaded to a computer and further analysis is performed. Vibration data is also collected continuously by permanently installed vibration monitors such as the CSI Model 4500T also manufactured by Computational Systems, Inc. This continuous data is transmitted to a computer for analysis when some transient or other event of interest has occurred.

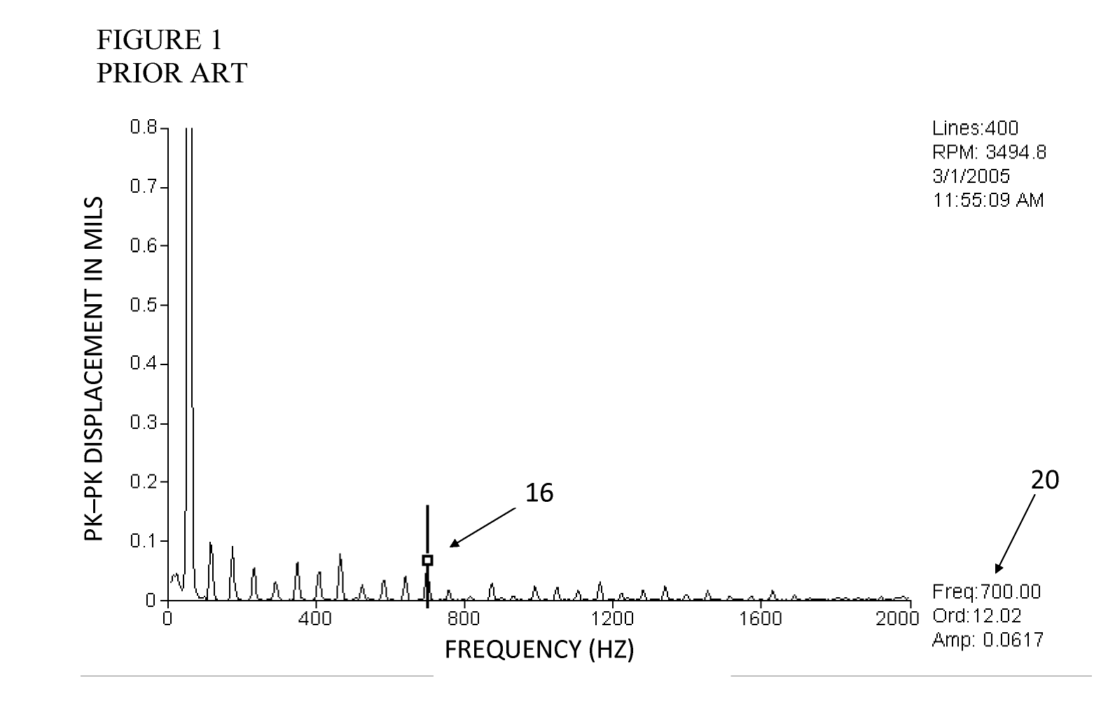

Often, the most effective way for an experienced vibration analyst to examine machine data is through interactive displays, such as the interactive display on a portable analyzer (e.g. CSI 2130) or the display of a computer, where cursors may be moved through the data sets to cause the display to report detailed information about selected points. When dealing with two-dimensional displays, simple cursors are readily visible as shown in FIG. 1 which displays a vibration spectrum for a piece of rotating equipment.

Referring to FIG. 1, the analyst, using a mouse, a keyboard, or other input techniques, moves a cursor 16 over the data. In FIG. 1, the cursor is represented as a square marker drawn around the data point where the cursor is located. The square marker is used to indicate that this cursor is the “active” cursor. In this example, vertical lines are added above and below the marker to enhance the visibility of the cursor. As the cursor moves, the display is updated to show the data values at the position of the cursor. In the figure, the text 20 at the lower right indicates the frequency at which the cursor is positioned, both in orders and Hz and the amplitude of vibration at that frequency.

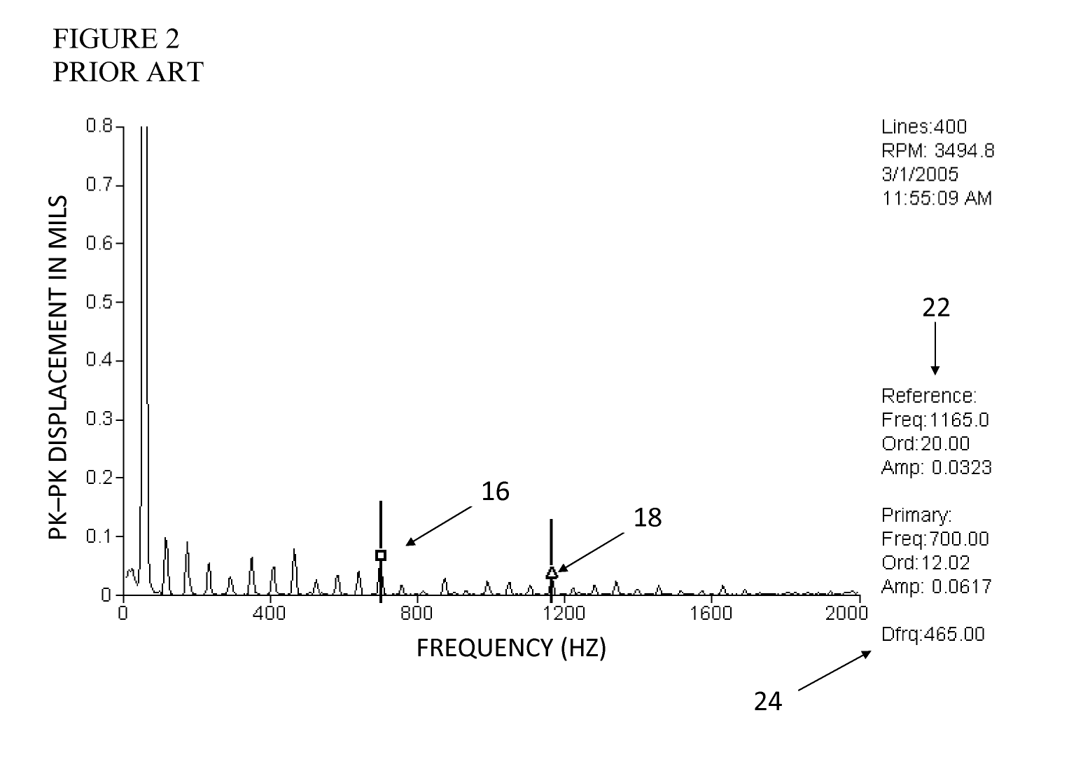

Often the analyst will use multiple cursors to permit measurements to be taken. FIG. 2 demonstrates the use of two cursors to determine the difference between two values. As in the previous example, the active cursor 16 is identified with a square marker. The reference cursor 18 has a triangular marker. Each cursor may be moved independently using a mouse, a keyboard, or other input techniques. As the cursors move, the readout 22 at the lower right now shows not only information about the data at each cursor, but also includes the frequency difference 24 between the cursors—a very important measurement for vibration and other types of machine analysis.

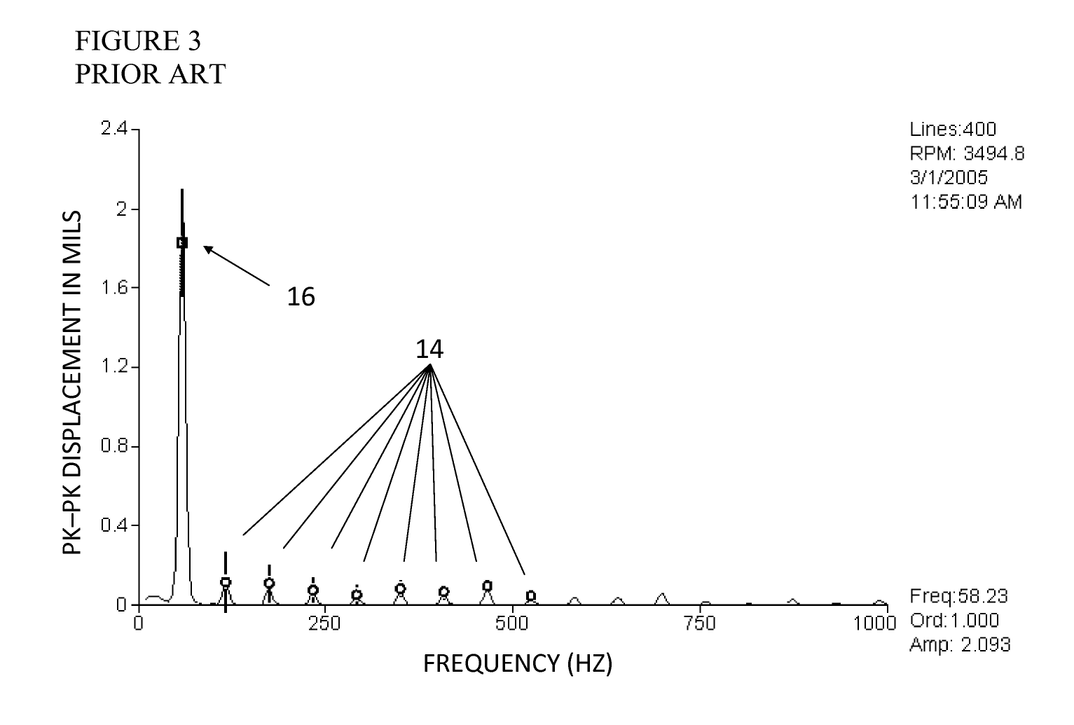

Due to the nature of vibration and other types of machine data, the existence of “families” of peaks with relationships between their frequencies are very significant. Specialized families of cursors can assist the analyst in the location of these features. FIG. 3 shows the use of harmonic cursors, a specialized cursor family which assists the analyst in identifying multiples of a frequency in spectral data. The active cursor 16 (indicated by the square marker) is positioned by the user at a specific frequency. The harmonic cursors 14 (with circular markers) are automatically positioned at integral multiples of the frequency of the active cursor. Note that the data represented in this figure shows numerous peaks that are harmonics of the rotation frequency (the largest peak—at the active cursor) of the monitored machine.

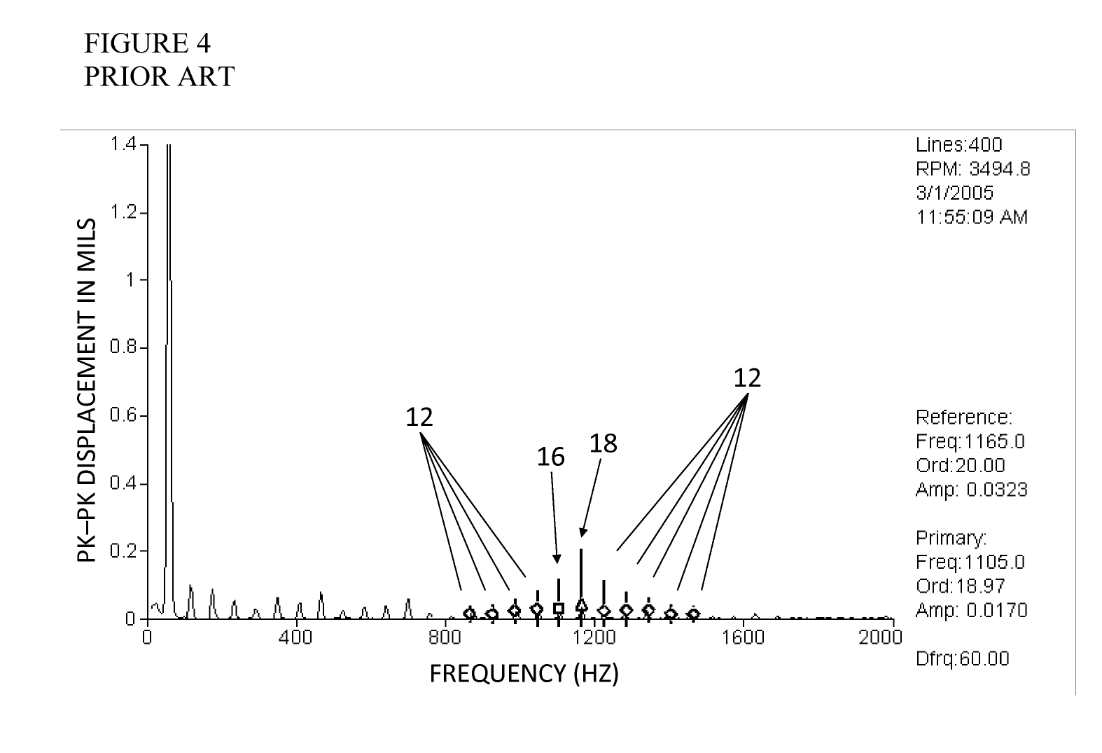

Another commonly used cursor family is shown in FIG. 4. These are sideband cursors which assist in identification of groups of peaks which are spaced at regular intervals about a given frequency. In this case, the reference cursor 18 (with the triangle marker) is placed by the user at a frequency of interest. Then the active cursor 16 (with the square marker) is positioned at a distance from the reference cursor. Sideband cursors 12 (with diamond shaped markers) are automatically drawn at multiples of the frequency difference about the reference cursor to help identify groups of sideband peaks.

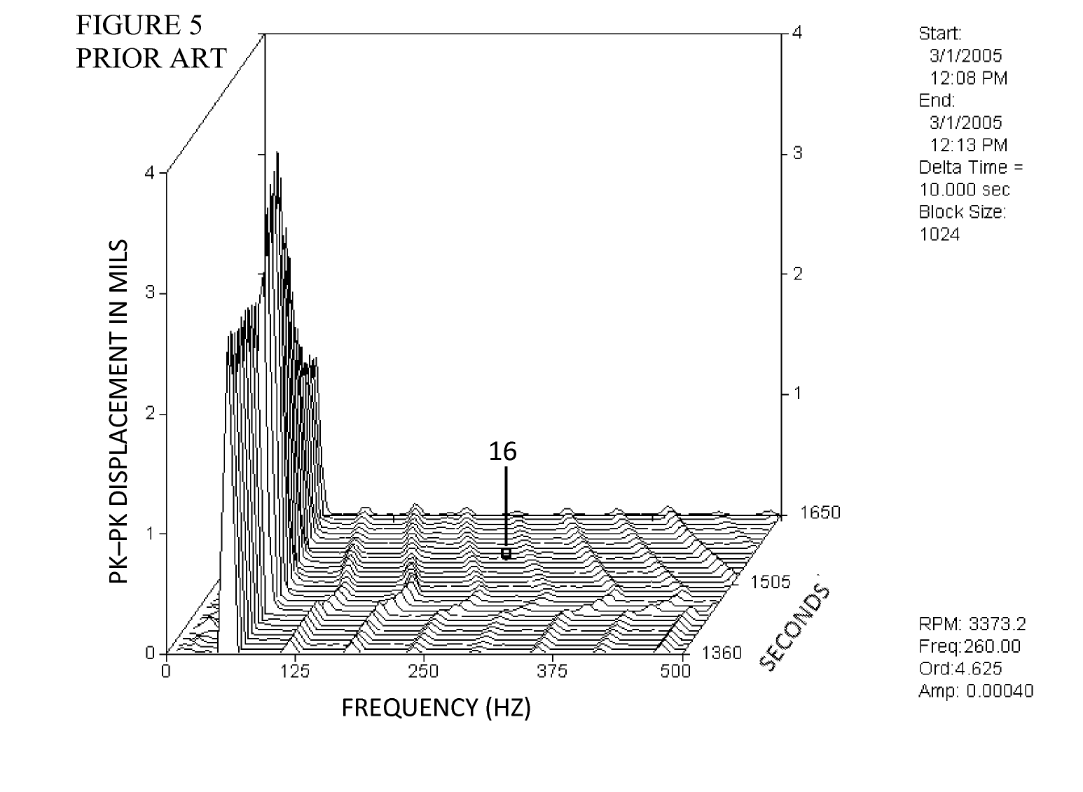

With recent improvements in machine data collection, storage and display, it has become possible to offer much more data to the analyst. An example of this is shown in FIG. 5. The data shown in the figure is a “cascade” of spectra taken periodically by a CSI Model 4500T system during the startup of a large steam turbine. Each of the data sets in the cascade is a spectrum similar to the data sets displayed by FIGS. 1 through 4. The cascade plots these spectra together to make changes in the vibration or other machine data characteristics of the machine more visible. Use of cursors in cascade plots or in other virtual three-dimensional machine data displays is also desirable. FIG. 5 clearly shows that by their very nature, three-dimensional plots are visually very “busy”. The techniques discussed above for representing cursors, as demonstrated by the active cursor 16 shown in the figure, are ineffective. Such cursor representations tend to “get lost” in the data.

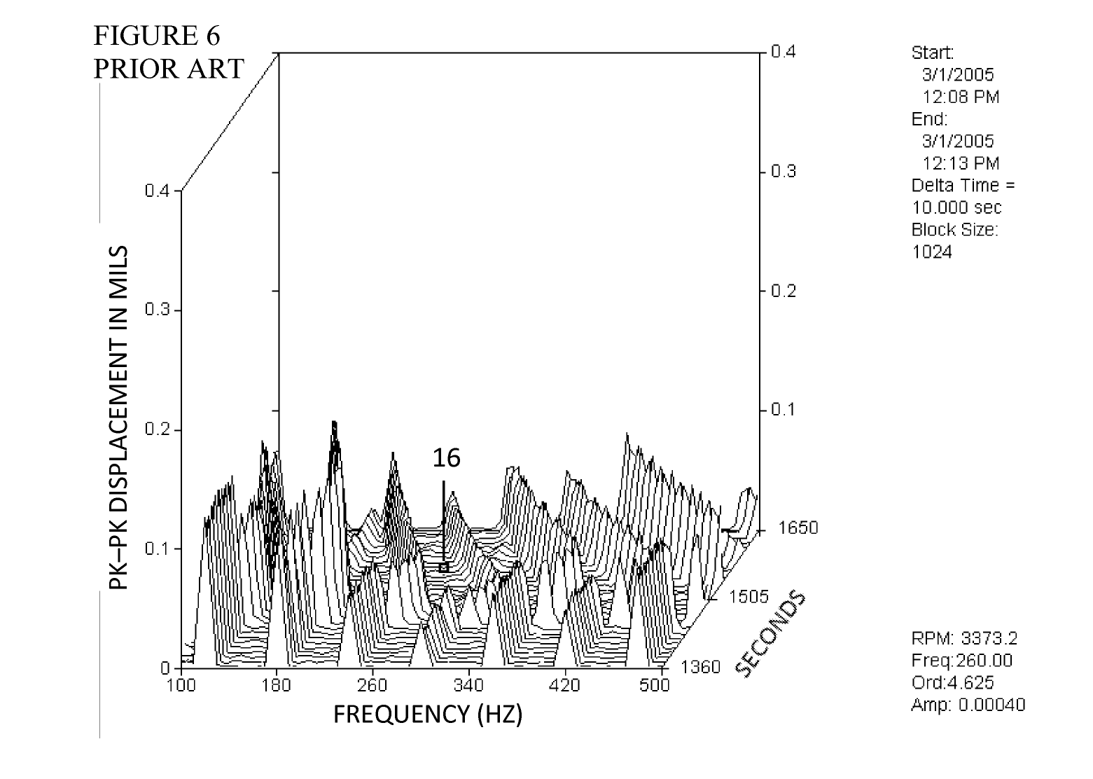

As shown FIG. 6, even when the display is “zoomed in” to the area of interest, the cursor 16 is quite difficult to locate visually. The cursor 16 in FIG. 6 was placed in a relatively “clear” spot so that it can be seen. However, as the analyst moves the cursor 16 near the peaks it can become very difficult to see. Furthermore, this type of cursor 16 can easily move behind data peaks and totally disappear from view.

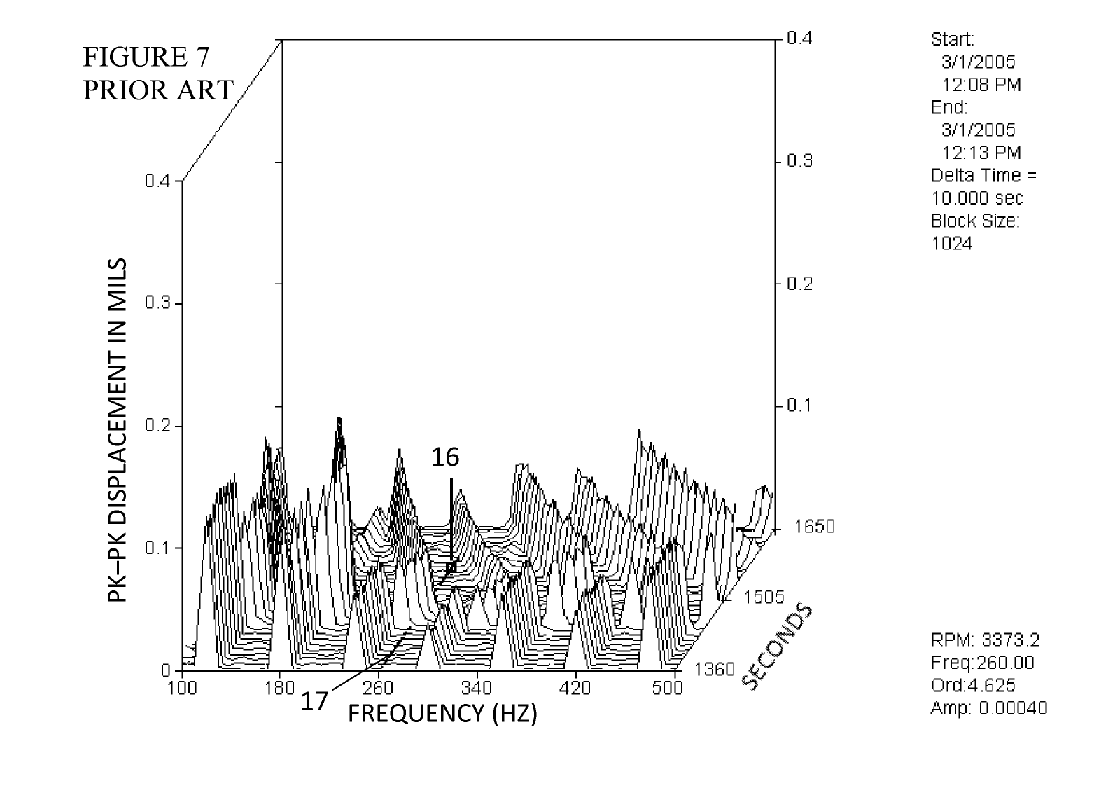

One approach used historically to assist in cascade type displays is the “floor” cursor 17 shown in FIG. 7. Note that placing the floor cursor 17 (the line along the floor of the plot) at the position of the cursor does help with visibility. However, the cursor can still easily “get lost” behind peaks in the data.

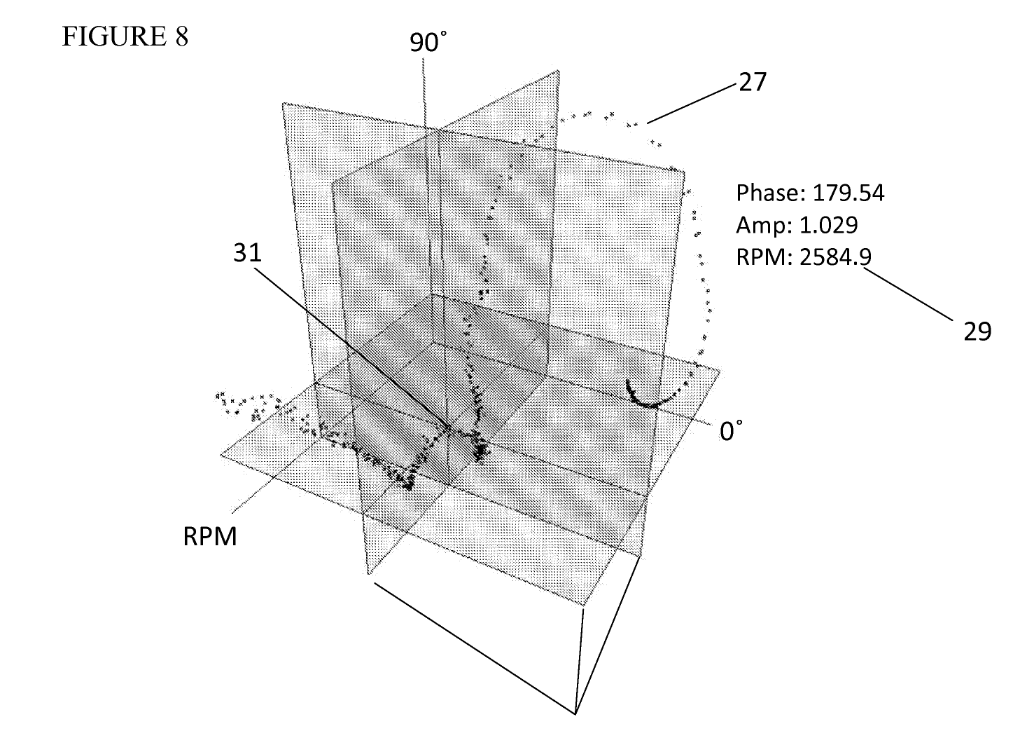

The use of semi-transparent plane cursors of the present invention solves these problems. One embodiment of this is shown in FIG. 8. That figure demonstrates the general case where semi-transparent plane cursors are applied to three-dimensional vibration data 27. In the figure, the data shown is peak-phase vibration measurements taken by a CSI Model 4500T system along a single plane of one of the turbine's bearings during startup. As the turbine's speed is increased, the peak vibration along the bearing's plane and the phase angle of that vibration was recorded. That data is plotted in FIG. 8 in three dimensions including peak, phase and RPM. Semi-transparent plane cursors 30 are used to identify a single point within the data. Each semi-transparent plane cursor 30 is rendered to appear much like smoked glass. That is, data (and other information) behind the plane is visible, but appears as though it were being viewed through smoked glass. Using a mouse, a keyboard, or other input techniques, the user may position each plane independently. As the planes move, the readout 29 at the right shows information about the data point 31 at the cursor—that is, at the point where the three planes intersect. As with the two-dimensional examples above, a square marker appears around the selected data point 31 to indicate that the active cursor is positioned there. In this embodiment, lines are also drawn along the intersections of the planes to further highlight the selected data point.

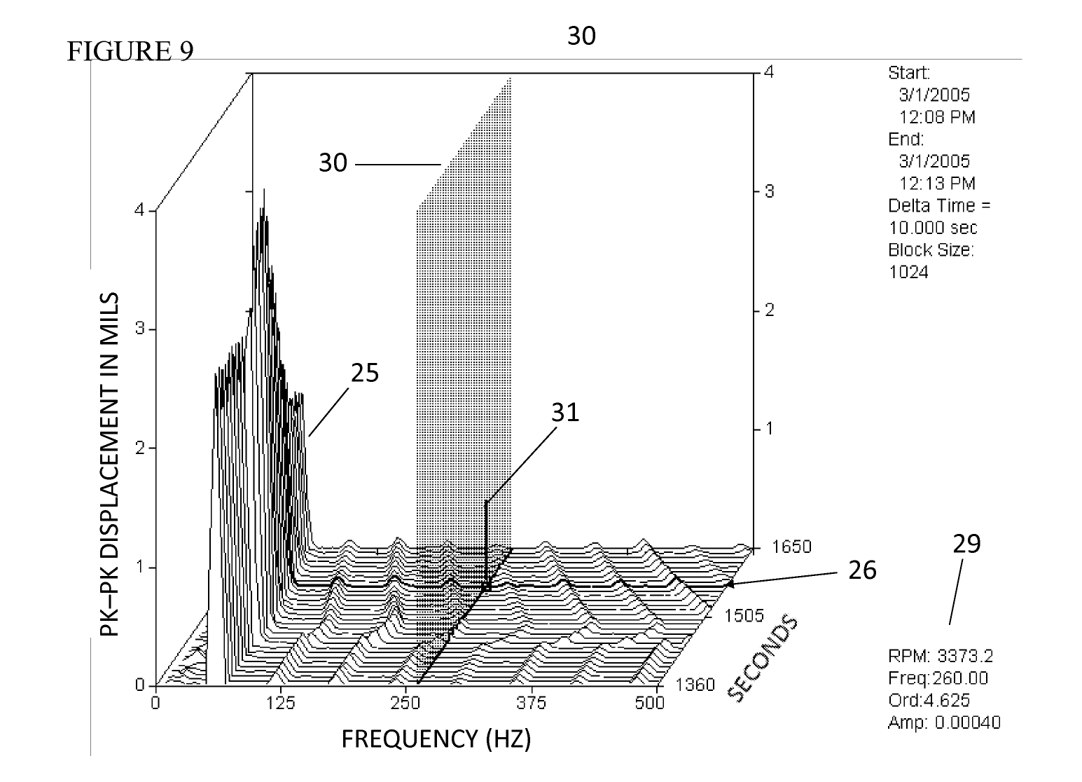

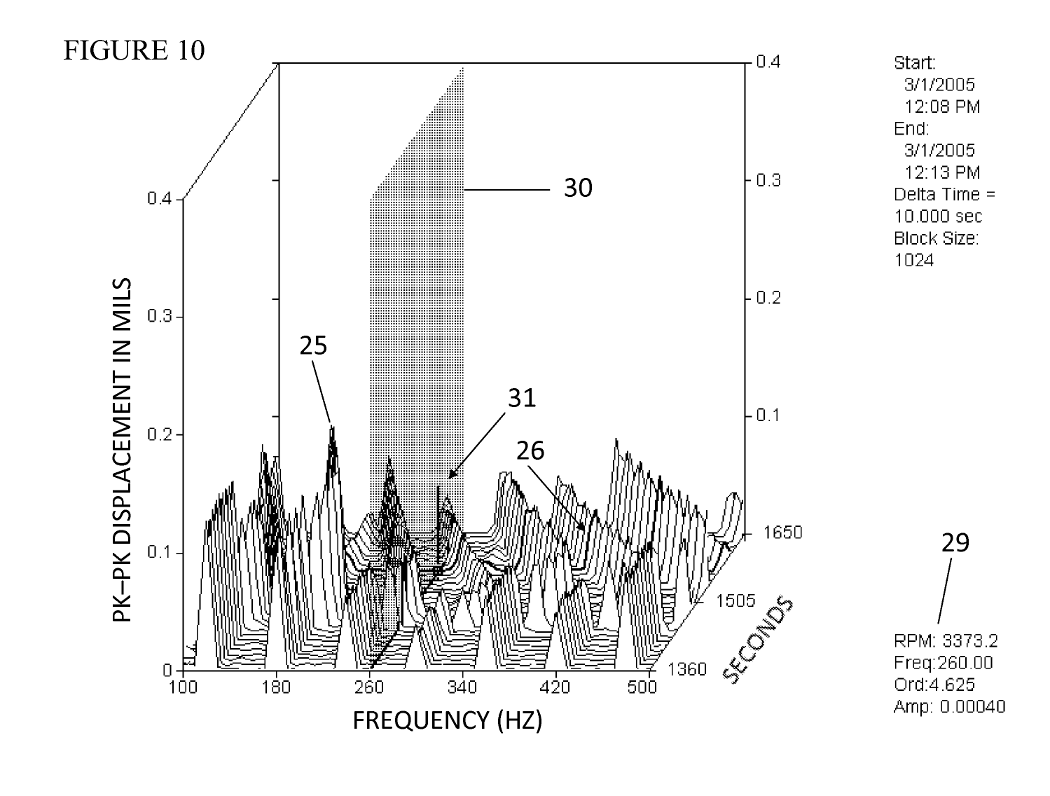

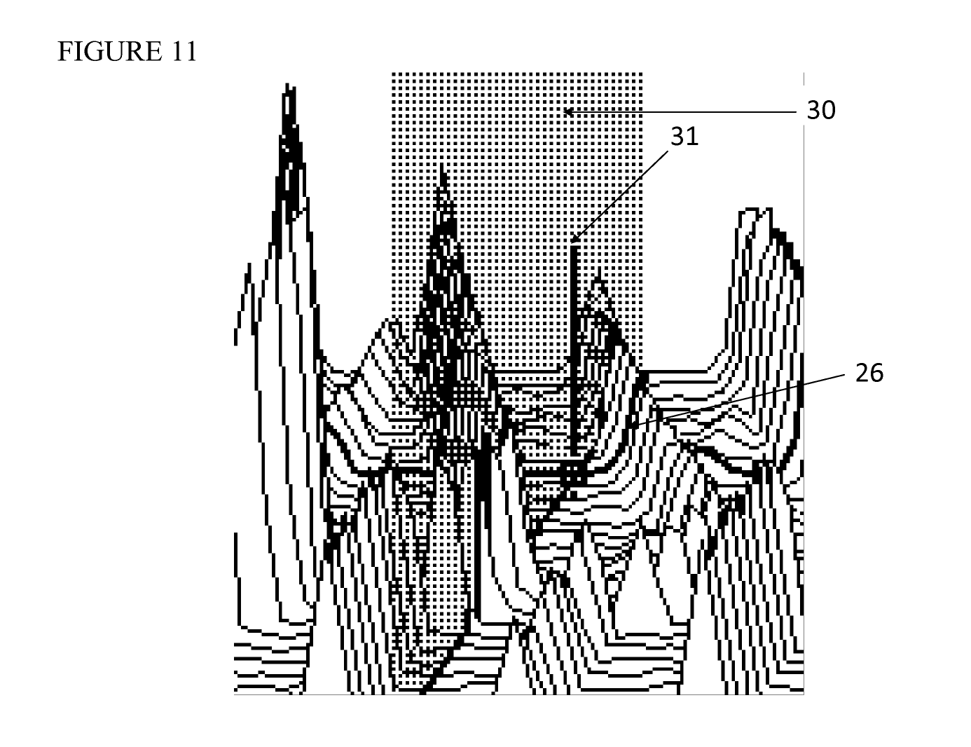

An alternate embodiment of the use of semi-transparent plane cursors with three-dimensional machine data is demonstrated by FIG. 9 and FIG. 10, in which vibration data 25 is plotted on a three-dimensional graph with displacement on a substantially vertical axis, frequency on a substantially horizontal axis, and time on an axis representing depth (the depth axis). In this cascade plot, each line of vibration data represents a spectrum calculated from vibration samples taken at different times during the startup of the turbine. While a cascade plot does represent three-dimensional data, the data is always rendered to appear like a surface. Because of this geometrical relationship, three semi-transparent planes are not required to uniquely identify a single data point 31. In this embodiment, a single plane cursor 30 is used to indicate the frequency. A second plane cursor could be used for identifying the data set (time) of interest. However, highlighting of the selected data set 26 can instead be used to identify the time of interest, without obscuring any other data sets. Since the cascade is a surface, the selected data point will be the point where the data surface, the data set indicator and the plane intersect. This representation makes it clear where the cursor is positioned at all times—even when the actual data point where the cursor is positioned is hidden from view. In this embodiment, the user may provide inputs through a mouse, keyboard or other input device to move the planar cursor 30 left or right along the horizontal axis. The user may also input commands to move the data set indicator 26 forward or backward along the depth axis. As in other embodiments, a square marker is drawn around the selected data point 31 to indicate that the active cursor is positioned there. As the plane and data set indicator are moved, information 29 regarding the vibration data at the selected data point is displayed. The close-up view shown in FIG. 11 demonstrates how the plane cursor 30 appears to cut through peaks providing clear indication of its location.

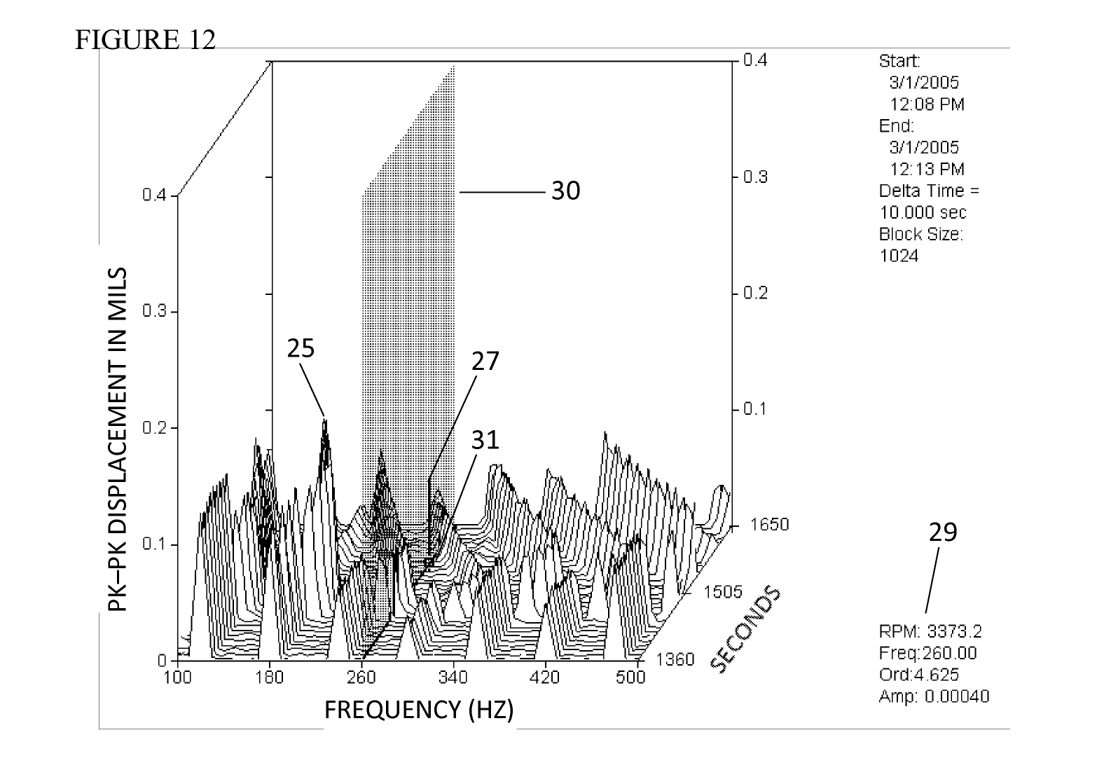

Using visual drop down menus on a display, for example, or other user input techniques known to those skilled in the art in various software suites, a user may select the type of indicator to be used for each data dimension. When dealing with a cascade plot, for example, the user might prefer to display a second semi-transparent plane cursor at the selected data set rather than highlighting the trace of the data set. If desired, a horizontal plane cursor could also be used to identify the displacement coordinate of the selected data point. Alternately, as shown in FIG. 12, the user might prefer to use the plane to indicate frequency and a line 27 above the marker to identify the selected data point 31.

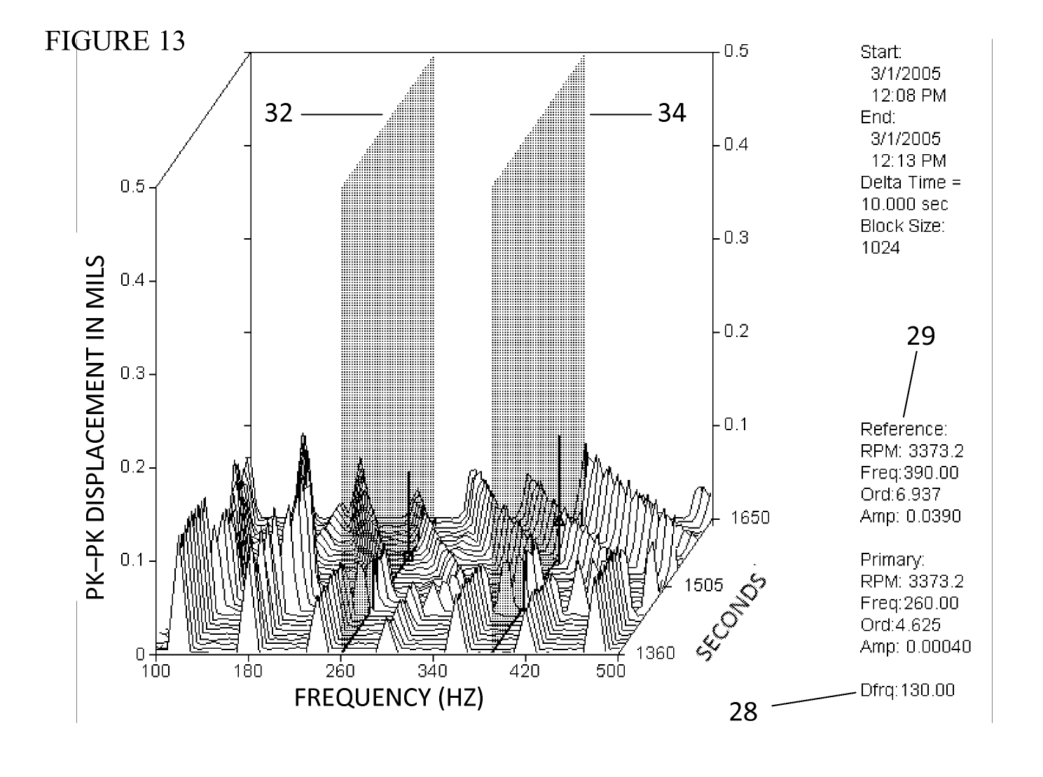

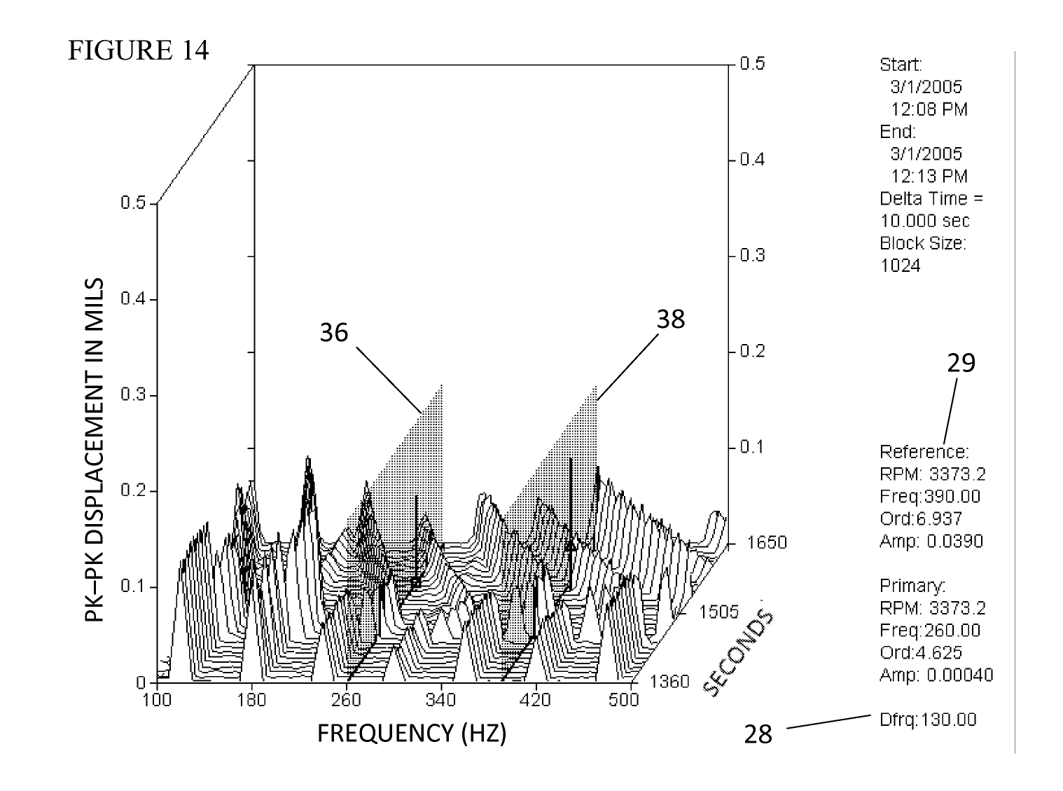

Any number of planar cursors may be placed on the display at the same time. The plane cursors 30 may be drawn in any color at any desired height, and FIGS. 13 and 14 illustrate different height cursors. Again, the user controls the height of the cursors 32 and 34 by providing user commands. The cursors 32 and 34 on FIG. 13 are taller than cursors 36 and 38 shown in FIG. 14, but both cursor sets are positioned identically relative to the data. In some applications the ability to vary cursor height will enhance the clarity of the information shown and in some cases a shorter cursor will appear less busy and allow for more data to be shown on the same display. The information 29 displayed adjacent the machine data provides detailed information as to the machine data at the positions of the two planar cursors 32 and 34. In addition, the difference frequency 28 is displayed representing the frequency difference between the positions of the two planar cursors 32 and 34 (or 36 and 38).

When this embodiment is implemented on a personal computer, one way to move the various cursors is to use a mouse to drag the cursors 32, 34 (or 36, 38) and data set selectors to desired positions. Also, after a cursor is selected it may be bumped in fine increments using, for example, the arrow keys on the keyboard of the personal computer. Alternately, different keystrokes permit the user to step the cursor through points of a data set or between data sets as desired. For complete control, a dialog box can be opened which permits the user to specify exactly the coordinates for cursor positioning.

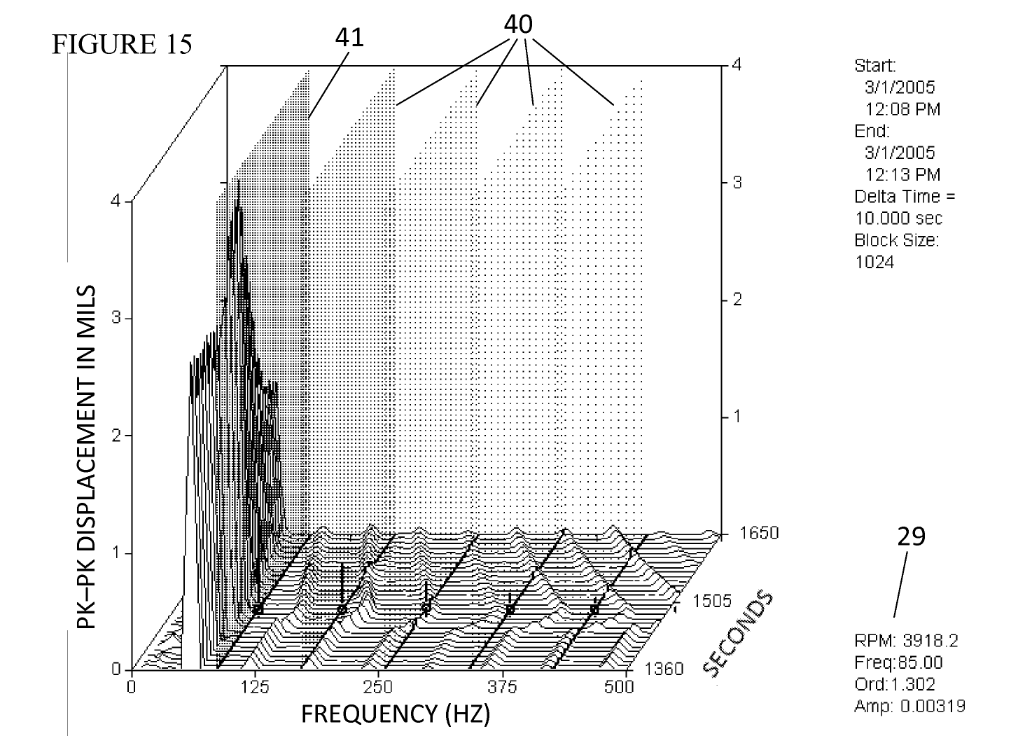

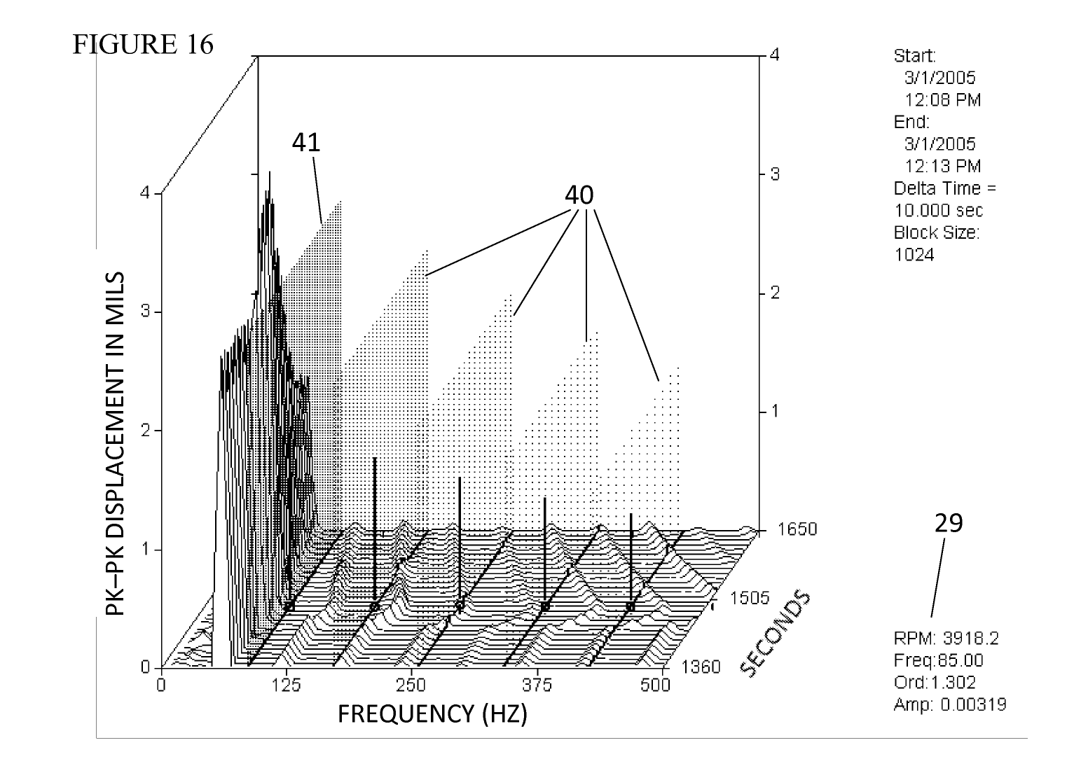

Additionally, as shown in FIGS. 15-17, the density (opacity) of the plane cursors can also be adjusted as needed. As the figures demonstrate, harmonic and sideband cursors can be represented quite effectively using semi-transparent plane cursors. FIGS. 15 and 16 show two examples of harmonic cursors 40. As in the two-dimensional case, the active cursor 41 (indicated by the square marker) is positioned by the user at a specific frequency. The harmonic cursors 40 (with circular markers) are automatically positioned at integral multiples of the frequency of the active cursor. Harmonic cursor mode may be enabled/disabled using a drop down menu or other techniques. The number of harmonic cursors displayed, their color, their density fade and/or height decay parameters are all selectable using drop down or pop up menus or some other techniques.

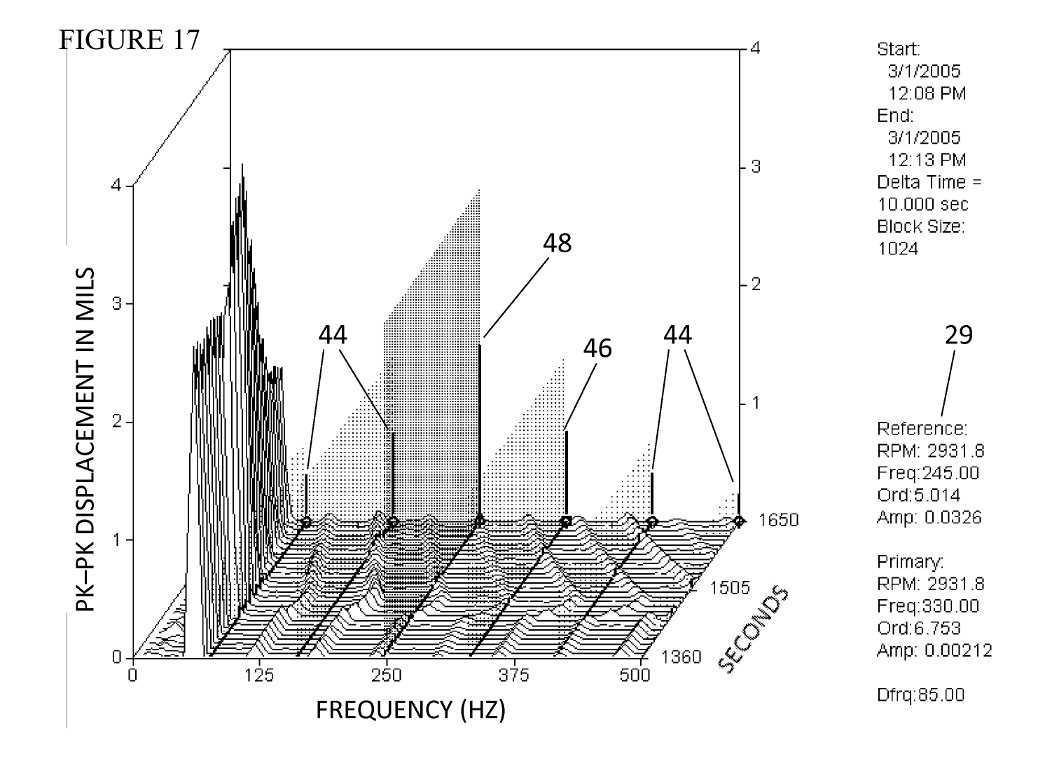

An example of possible display of sideband cursors 44 on a cascade plot is shown in FIG. 17. As in the two-dimensional case, the reference cursor 48 (with the triangle marker) is placed by the user at a frequency of interest. Then the active cursor 46 (with the square marker) is positioned at a distance from the reference cursor. Sideband cursors 44 (with diamond shaped markers) are automatically drawn at multiples of the frequency difference about the reference cursor to help identify groups of sideband peaks. In this embodiment, the planar sideband cursors 44 are chosen with different heights with the cursor height becoming smaller as the cursor is positioned further from the reference frequency. In other words the higher order side bands are designated with shorter planar cursors. In this embodiment, it is shown how each cursor 44 is still visible even when it is behind another cursor 44.

One of the strengths of modern machine monitoring systems (specifically the CSI 4500T) is their ability to simultaneously acquire continuous, unbroken waveform data from multiple signal channels, each having extremely accurate corresponding tachometer pulses. From data of this type, numerous multi-dimensional data sets can be generated and displayed which can prove extremely valuable in analysis of vibration and other parameters during transient operation of various types of rotating equipment or other mechanical devices.

Those skilled in the art appreciate that other types of indicators may be used other than substantially planar cursors. Such other indicators may include other geometric shapes depending on the type of data that is being monitored and the type of machine being monitored. For example, a semi-transparent virtual three-dimensional cylindrical object image may be inserted into a three-dimensional graph to visually indicate an operational zone. The operational zone may be defined as a zone in the machine data that corresponds to safe operating conditions for monitored machinery. Safe machine operating conditions (or safe machine operation) may be understood as conditions that preserve the physical integrity of the machinery other than common wear and tear caused by friction and other common forces that cannot be easily avoided. For example (as when a turbine is monitored using this technology), shaft damage (i.e., unsafe machine operation) may be defined and understood by a data analyst as imminent when data strays outside of the visually indicated operational zone. In yet another embodiment, a geometric shape such as a semi-transparent virtual three-dimensional sphere may be used to designate an operating zone in which a particular device operates at a most desired efficiency level.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of displaying machine data comprising the steps of:
a. receiving machine data at a device having a display;
b. displaying an image corresponding to the machine data on the display in a three dimensional graph, the graph including a first axis, a second axis, and a third axis; and
c. displaying a two dimensional primary cursor image representing a substantially planar cursor shown in virtual three dimensional space disposed on the three dimensional graph on the display.

2. The method of claim 1, further comprising the step of moving the primary cursor image on the display in response to user input to intersect the machine data at one or more desired locations along the displayed data.

3. The method of claim 2, further comprising the step of outputting information corresponding to the machine data at the intersection of the primary cursor image and the machine data.

4. The method of claim 1 wherein the step of displaying an image corresponding to the machine data further comprises displaying an image corresponding to vibration data.

5. The method of claim 1 wherein the machine data corresponds to vibration produced during the transient operation of rotating equipment.

6. The method of claim 4 wherein the machine data comprises vibration data including information corresponding to vibration peak amplitudes and frequencies, phase angle of vibration, and RPM of a rotating device.

7. The method of claim 1 wherein the step of displaying a primary cursor image comprises displaying a primary semi-transparent cursor image whereby the data behind the primary semi-transparent cursor image in the three dimensional graph is partially obscured and partially visible.

8. The method of claim 1 wherein the step of displaying a primary cursor image comprises displaying a primary semi-transparent cursor image in an orientation parallel to one of the axes of the graph and perpendicular to the other two axes.

9. The method of claim 1 further comprising the step of displaying a plurality of secondary cursor images representing substantially planar cursors on the display, wherein the secondary cursor images are spaced apart from the primary cursor image in a pattern corresponding to characteristics of the machine data.

10. The method of claim 1 further comprising the step of displaying a plurality of secondary cursor images representing substantially planar cursors on the display, wherein the secondary cursor images are spaced apart from the primary cursor image in a pattern corresponding to input from a user.

11. The method of claim 9 wherein the step of displaying a plurality of secondary cursor images comprises displaying secondary cursor images such that the image characteristics of the secondary cursor images vary based on the position of each secondary cursor image with respect to the position of the primary cursor image.

12. The method of claim 1 further comprising the step of displaying a dialogue box that permits a user to input specific desired coordinates for the positioning of the primary cursor image along the displayed data.

13. A method of displaying machine data comprising the steps of:
a. receiving machine data at a device having a display;
b. displaying an image corresponding to the machine data on the display in a three dimensional graph, the graph including a first axis, a second axis, and a third axis; and
c. displaying on the display a plurality of semi-transparent cursor images representing substantially planar cursors in virtual three dimensional space;
d. and partially obscuring the data on the three dimensional graph that is behind the cursor in virtual three dimensional space as viewed by a user, whereby the data behind the planar cursors in the three dimensional graph is partially obscured and partially visible.

14. The method of claim 13, further comprising the step of moving at least one of the planar cursors on the display in response to user input to intersect the machine data at one or more desired locations along the displayed data.

15. The method of claim 13, further comprising the step of outputting information corresponding to the machine data at the intersection of at least two of the planar cursors and the machine data.

16. The method of claim 13 wherein the step of displaying an image corresponding to the machine data further comprises displaying an image corresponding to vibration data.

17. The method of claim 13 wherein the machine data corresponds to vibration produced during the transient operation of rotating equipment.

18. The method of claim 16 wherein the machine data comprises vibration data including information corresponding to vibration peak amplitudes and frequencies, phase angle of vibration, and RPM of a rotating device.

19. A method of displaying machine data comprising the steps of:
a. receiving machine data at a device having a display;
b. displaying on the display an image corresponding to the machine data on the display in a three-dimensional graph, the graph including a first axis, a second axis, and a third axis; and
c. displaying a semi-transparent object image extending along one of the axes, wherein the object image represents a defined operational zone for the displayed data in virtual three-dimensional space.

20. The method of claim 19 wherein the step of displaying a semi-transparent object image further comprises displaying a semi-transparent object image such that the object image represents a zone that designates safe machine operation.

21. The method of claim 19 wherein the step of displaying a semi-transparent object image further comprises displaying a semi-transparent object image such that the object image represents a zone that designates optimal machine operation.
